(19) United States
(12) Patent Application Publication
(10) Pub. No.: US 2008/0300778 A1
(43) Pub. Date: Dec. 4, 2008

(54) SYSTEM AND METHOD FOR PERSONALIZING TRIP ASSISTANCE ON A DIGITAL MAP

(75) Inventor: Tsia Kuznetsov, Cupertino, CA (US)

Correspondence Address: FLIESLER MEYER LLP, 650 CALIFORNIA STREET, 14TH FLOOR, SAN FRANCISCO, CA, 94108, US

(73) Assignee: TELE ATLAS NORTH AMERICA, INC., Lebanon, NH (US)

(21) Appl. No.: 12/128,966

(22) Filed: May 29, 2008

Related U.S. Application Data
(60) Provisional application No. 60/940,793, filed on May 30, 2007.

(51) Int. Cl. G01C 21/00

(52) U.S. Cl. 701/200

(57) ABSTRACT

A navigation system and method for personalizing trip assistance on a digital map for a user, including data, software (application) and hardware (H/W) components that track a trip of the user, log the trip data in a data base, classify the logged trip data by time of day, day of week and date, process and analyze the trip data, and store and retrieve the results of the analyzed trip data to assist the user.

### CLAIM OF PRIORITY

This application claims priority under 35 U.S.C. 119(e) to U.S. Provisional Application No. 60/940,793, filed May 30, 2007, entitled “SYSTEM AND METHOD FOR PERSONALIZING TRIP ASSISTANCE ON A DIGITAL MAP” by Tsia Kuznetsov, which application is incorporated herein by reference.

### FIELD OF THE INVENTION

The present invention relates to route planning to assist travelers.

### BACKGROUND OF THE INVENTION

Use of digital maps for route planning became common place with the proliferation of internet mapping services and personal navigation devices such as Personal Digital Assistants, cell phones and OEM navigation systems. Most systems collect and process feature user profiles to identify personal preferences for computing a path for guiding a traveler or for adjusting cost settings. These profiles are typically static, while more advanced systems allow a user to enter data to give the system a more personal touch. A user with a local knowledge may know a better path, however a traveler usually has to enter one or more waypoints to ensure that a system plans the route using roads of personal choice.

### SUMMARY OF THE INVENTION

An objective of this invention is to personalize travel assistance on digital maps by recording, analyzing and using traveler trip patterns for route planning and guidance.

User trip data is a basis for the personalization method and apparatus of the present invention. A use-case of a single-driver embedded navigation system may be considered as one example. A trip may be defined as a path traveled by the vehicle between two moments in time: ignition on/off. In a more general sense, a trip is a path traveled between two locations meaningful as an origin and a destination, independent of the method to identify these locations in a recorded data stream. On a handheld device, a combination of on/off switch and a rate of change in the device position could be used to determine a start or an end of a trip, while an internet site may provide user space for trip logging. The present specification refers to an origin and destination as a logical begin/end of a trip, no matter whether explicitly selected by the user, or inferred algorithmically. Most users would not request a path when making a trip from a familiar location to another familiar location; these trips nevertheless are also subject for the system learning module. A trip does not assume a pre-computed path, nor does a pre-computed path have an effect on a trip definition.

The navigation system of the present invention assumes a modern trip assistance computer that includes a CPU with processing power to analyze trip data without interfering with regular navigation functions or off-line, an I/O device to store and retrieve results of the analysis, means for wired and/or wireless communication, means of position tracking (for instance, a GPS device, or one using a radio beacon approach, possibly aided by other devices such as inertial sensors, distance measurement instruments, lasers, cameras, etc.). The system also has a map data base, and a personal trip data base, along with data logging capabilities that records traveled tracks along with a clock with time of day, day of the week and date for each point. These devices may be entirely on an autonomous system, or distributed between a client and a server.

Each trip, its origin and destination locations are logged and classified by time slot and usage counter.

Depending on the time slot, a driver may favor one path over another between the same locations; thus a time interval is logged for each trip and location.

This trip data collection allows for deriving useful information, such as:
Driver's preference for certain functional road classes over others (such as freeway vs. arterial, or vice versa), computed against the system's generic “best” path;
Driver's trade-offs between a simpler path vs. a shorter or faster path with increased number of maneuvers, and degree of willingness to trade miles for time;
Driver's speed on various road classes, in comparison to predictive or real-time averages;
Actual cost of turns to compute an average cost by turn type for this driver;
Detection of data errors such as missing connectivity, geometry, or its shape;
Most frequent origins and destinations for every time slot.

These data provide a foundation for the analytical engine to derive knowledge about driving patterns, to be used by the algorithm that mimics a user's intuitive trip planning to unobtrusively direct the commuter toward a personally preferred path that travels through a familiar network.

### BRIEF DESCRIPTION OF THE DRAWINGS

FIG. 1 illustrates a map with trips recorded by the system of the present invention for the time slots listed on this illustration;

FIG. 2 illustrates a map showing location clusters;

FIG. 3 illustrates a map with shared trip segments forming personal compound links at different levels; and

FIG. 4 illustrates the data, application components and hardware (H/W) of a trip assistance computer.

### DETAILED DESCRIPTION OF THE INVENTION

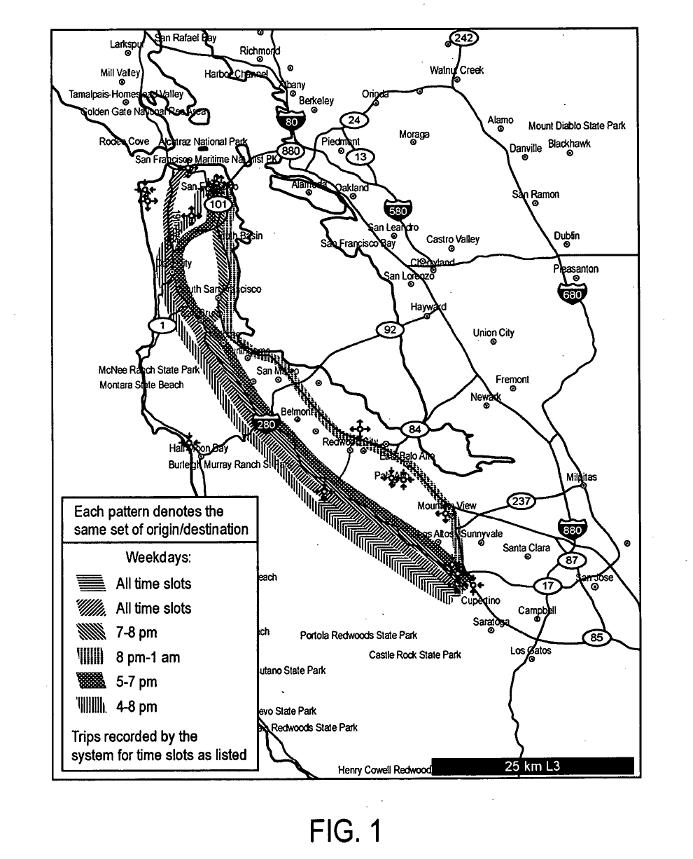

In accordance with the present invention, analysis is performed on origin and destination locations, as well as recorded trips. The system implements an ability to reference a trip traveled by the user in terms of routing links (segments of road between 2 decision points), and modify a link's traversal cost for a given time interval. A virgin personal trip data base (DB) is started. As time goes by, this data base is populated with locations and trip data referenced to routing links. The routing network combines a familiar universe of path links referenced in the personal DB due to recorded trips and a huge, unfamiliar (to the learning system) universe of map links in the original routing data. The familiar universe slowly grows over the lifetime of a system (see FIG. 1).

Some origin and destination locations statistically stand out from others. A home location is likely to be most frequently visited, perhaps followed by a work location, a school, a child care facility, a gym, etc. For most users, trips between high frequency locations occur periodically on certain days/dates, and within certain time intervals. For instance, many drivers would go to work at the same time of the day on weekdays, and return home roughly at the same time. Others would drive to school to drop a child off, and then go to work, or back home, or to some other high-frequency location.

Depending on the time and the day, a driver may favor one path over another between the same locations; thus time logging for each trip link and endpoint locations is an important consideration in analyzing user patterns in selecting a path. All these data need to be organized for efficient analysis and consequent utilization by the system route planning and guidance functions.

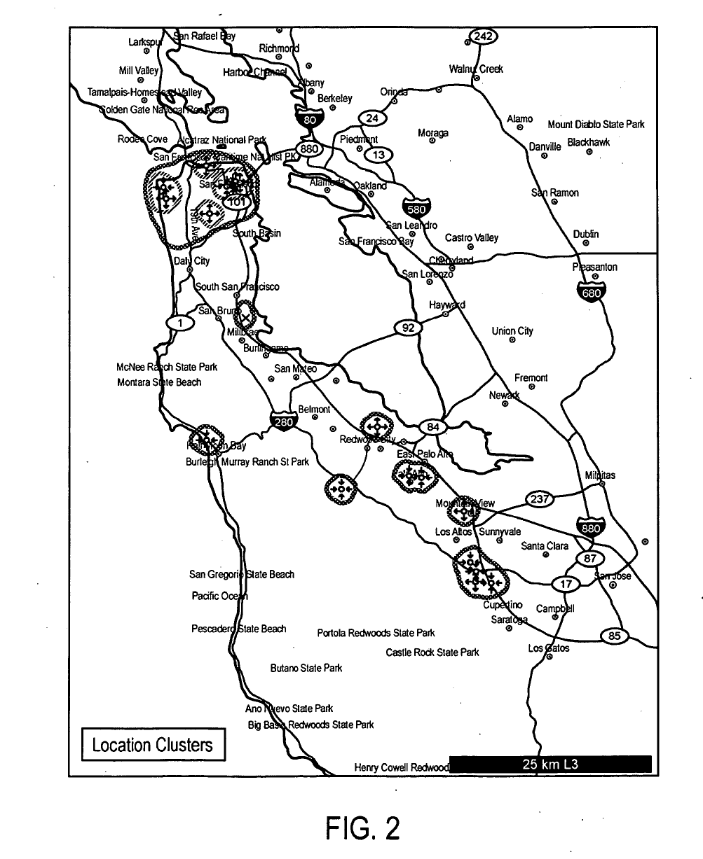

To visualize the data, origin and destination locations may be plotted on the map with a green marker (or “O”) for an origin, and a red marker (or “D”) for a destination, and user trips drawn between them. Some of these origin and destination locations form clusters (locations in near proximity of each other). Other locations could be near a path from one cluster to another cluster. Assume that a clustering algorithm partitions locations into clusters such that while clusters have an extent, they need not cover the plane, and neighbor clusters could be detected. Depending on a cluster extent and other criteria such as population and neighbors, a cluster is subdivided into smaller clusters. Thus there is a hierarchy of clusters, although limited for a typical non-commercial user (see FIG. 2).

Not all clusters have recorded origins or destinations for trips. When they do, for a given time slot, trips from locations in a cluster to locations in another non-neighboring cluster may have shared segments covering a chain of path links.

Occasionally these regular trips may have small aberrations (for instance, a driver stopping to buy coffee or fill up a gas tank). Location of a coffee shop and a gas station may be added into the system as an origin or destination if the ignition is turned off. However, these tiny detours may be detected and removed since such locations possibly may not be that important.

There are available prior algorithms that guarantee fast path computation by partitioning map data into tiles and pre-computing all tile-to-tile links, at the huge compute time and storage expense. In effect, the user location clusters and user trips of the present invention serve the same purpose, but now as personalized, dynamically computed and maintained tiles.

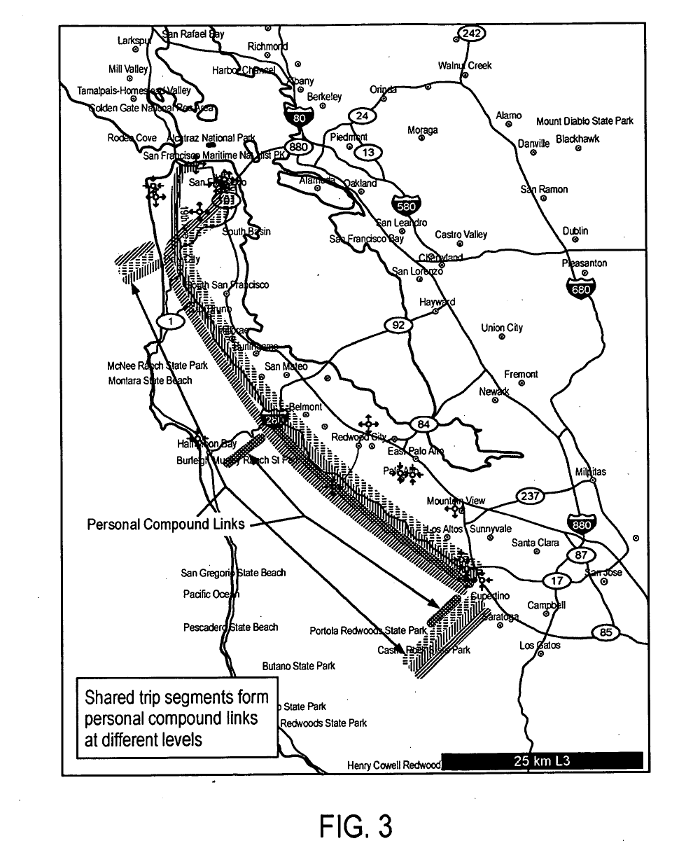

In a prior shortcut-type algorithm a way to pre-compute paths that are instrumental for driving to destinations is available in a range of exploration limits expressed via Euclidian distance. Output of this process is a hierarchy of compound routing links, which are chains of elementary routing links defined as a directed link between 2 decision points on a graph. Compound links are integral to fast path computation in allowing the skipping of unimportant details. Common parts of the recorded trips in effect serve the same purpose. The added benefit is that they express de-facto user-preferences, as opposed to generic map data traversal costs, and are dynamically changing in sync with user preferences. In footsteps of the shortcut algorithm, a set of shared contiguous trip segments is chained into a single personal compound link (see FIG. 3). These links are added to the personal links data store, which supplements elementary path links and pre-processed compound links in the original data base. Personal compound links of various distances may form a natural hierarchy, and in some instances contain or overlap pre-computed compound links, all of which facilitates referencing and compression.

Each pair of clusters references a set of from-to and to-from personal links that were used to connect them.

Assume now that a new origin and/or a destination falls into two non-neighboring clusters. In that case, the system selects personal links in the appropriate direction between these two clusters, and makes traversal time for this select personal link subset inexpensive, especially for a matching time slot. This may ensure a familiar route preferred by the user, unless a traffic incident modifies costs for some personal link: all trips are subject to run-time evaluation for real-time incidents and predictive traversal times.

If a new origin or destination is not inside any cluster, but along a vector from two existing clusters, the same technique may apply, selecting a subset of personal links between those clusters inexpensively.

Such subset of personal links may be helpful in computing an alternative path.

Routing links around this selected subset of personal links may be made inexpensive in a smooth continuous fashion, such that links are weighted proportional to their proximity to a personal link in graph distance. Thus the graph would be warped to bias well traveled paths.

Alternatively, if a user is adventurous and prefers unfamiliar routes, compound and simple path links from the familiar universe may carry penalty for traversal, to favor unknown paths over known paths.

Personal trip knowledge data base can have a profound effect on the system human-machine interface by providing a meaningful guidance when the user needs it, dramatically reducing annoying guidance clutter. Suppose also that a user is in a familiar universe, not bothering to enter a destination. Based on time/day, the system could make an assumption that a destination is one of high-frequency locations for that time interval. Thus, the system may match user movements against the presumed path, and so long as the assumption of the destination holds, provide travel assistance, such as alerting the user about incidents on this non-explicitly asked for path.

Conversely, if a path has been computed, and a user has chosen another path, then the cost for the part of the original path that was deliberately avoided could be made higher (unless the path preferred by the user could be classified as an aberration and a majority of later trips still travel the computed path).

Considering a relatively small amount of personal data, necessary computations can be performed as a background task on a multi-core modem CPU.

As navigation system processors become more potent, more sophisticated algorithms may be used to deduce cost function parameters such that they generate paths closely matching user trips, to apply to route planning in the unfamiliar universe.

Personal preferences positively inform human-machine interface. If a user is in an unfamiliar universe, knowledge of location clusters/time/day may enhance an outcome for guidance without a destination by suggesting possible ways to reach a familiar universe rather than any given destination. The familiar universe might be as simple as a user-frequented and nearby highway.

When a personal compound link is used to compute a path, then depending on the recorded frequency of the link the application may choose to forgo turn-by-turn guidance, breaking the “silent” mode only in case of a relevant change in the context (getting off the path, a traffic message, low gas gauge, etc.).

Furthermore, given user interaction with the system, Human-Machine Interface could be adjusted to the user's patterns. If a user frequently turns off the volume to suppress guidance instructions, the system may choose a terse mode of guidance (“Keep on I-5 for 300 miles” vs. a number of instructions to “Keep left to stay on I-5”). Vice versa, if the user is turning the volume up, or frequently misses a maneuver, then more detailed instructions are due. In that case, a point of interest (POI) and road furniture data linked to the path road elements may be searched to provide more human like instructions: “Turn left in 300 feet at the Shell station”. The application may also adjust timing of instructions, once traveler behavior betrays a nervous driver that needs to be pacified.

Multi-modal traveling with a hand-held device presents another aspect of building a knowledge data base. A trip when a traveler reaches a destination, loses a GPS signal, and who some time later emerges at a different location suggests that part of the trip was, for example, on a subway (underground) train, which could be verified by a search for appropriate POIs at those locations. Similarly, a train track could be observed. A trip on the bus could be identified by correlating bus stop POIs with stops detected via the GPS position unit. Once such deduction is computed, the system may silently access a public transportation server to search for and alert the user about relevant transport delays, strikes, change in schedule, etc.

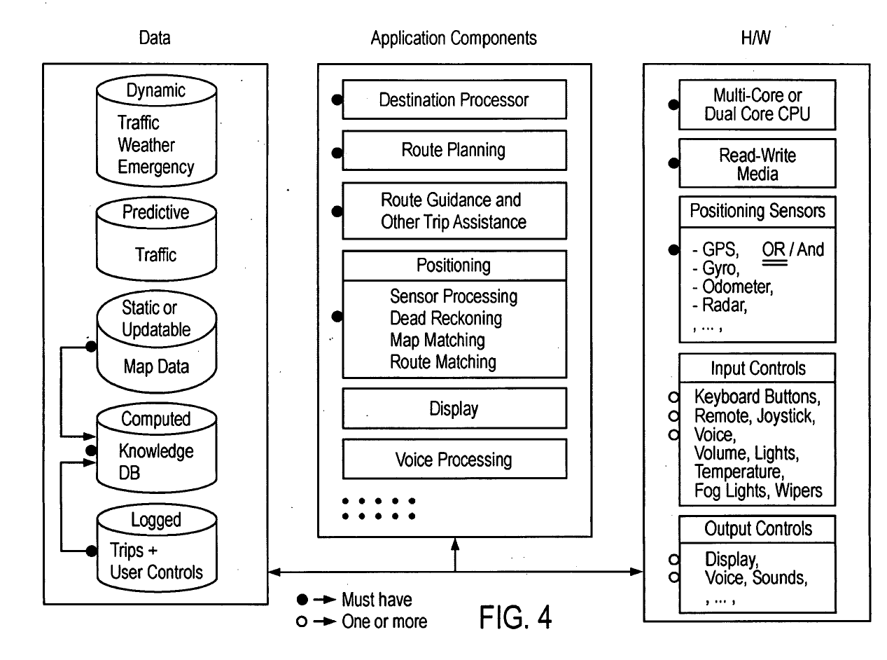

FIG. 4 illustrates diagrammatically a trip assistance computer to provide the personalized trip assistance information on a digital map data. The trip assistance computer includes data, application and hardware (H/W) components. As shown, the data components include dynamic data such as weather, predictive data such as traffic, static data such as digital map data, computer data which is a knowledge base, and logged data such as trip data, as well as other data indicated on FIG. 4.

The application component includes trip destination processing, route planning, route guidance trip assistance, vehicle positioning processing including sensor processing, dead reckoning and map matching processing and route matching, map display processing, and voice processing, as well as other processing indicated on FIG. 4.

The hardware (H/W) component includes a CPU, read-write media vehicle positioning sensors such as GPS, input controls such as a keyboard, and output controls such as a display control, as well as other H/W indicated on FIG. 4.

In summary, the present invention builds on prior technology and algorithms used in the past for pre-processing the entire extent of map data, to create a continuously updated traveler patterns data base in a navigation device, and make use of these data to enhance trip assistance and traveler experience with digital maps.

What is claimed is:

1. A navigation system, comprising:
a) means for tracking a trip of a user of the navigation system;
b) means for logging trip data in a data base;
c) a clock having time of day, day of week and date information to classify and log the trip data;
d) means for processing and analyzing the trip data without interfering with normal navigation functions of the navigation system; and
e) means for storing and retrieving the results of the trip data analysis.

2. A method for providing personalized travel assistance to a user of a navigation system on a digital map, comprising:
a) tracking a trip of the user;
b) logging the trip data in a data base;
c) classifying the logged trip data by time of day, day of week, and date;
d) processing and analyzing the trip data; and
e) storing and retrieving the results of the analyzed trip data to assist the user.
